(19) United States
(12) Patent Application Publication
(10) Pub. No.: US 2013/0291510 A1
(43) Pub. Date: Nov. 7, 2013

(54) FEED DRUM WITH AXIALLY TRANSLATING FINGERS

(71) Applicant: DEERE & COMPANY, Moline, IL (US)

(72) Inventors: BENJAMIN M. LOVETT, COLONA, IL (US); STEVE A. COON, MOLINE, IL (US); AUSTIN HUGHES, SALT LAKE CITY, UT (US)

(73) Assignee: DEERE & COMPANY, Moline, IL (US)

(21) Appl. No.: 13/785,996

(22) Filed: Mar. 5, 2013

Related U.S. Application Data
(60) Provisional application No. 61/643,152, filed on May 4, 2012.

(51) Int. Cl. A01D 61/00

(52) U.S. Cl. CPC A01D 61/008
USPC 56/16.4 R

(57) ABSTRACT

A feed drum for an agricultural harvesting head has fingers extending through the surface of the feed drum that translate laterally and generally parallel to the rotational axis of the feed drum as the feed drum rotates to compress the crop mat laterally inwardly toward a central axial portion of the feed drum.

### RELATED APPLICATIONS

This application claims priority from U.S. Provisional Patent Application 61/643,152.

### FIELD

This invention relates to feed drums for agricultural harvesting heads. More particularly it relates to feed drums with fingers that translate axially with respect to the rotational axis of the feed drum.

### BACKGROUND

Agricultural harvesting heads such as draper heads use left and right side endless belt conveyors to carry material toward a central portion of the harvesting head. Once there, a center conveyor receives the material from the left and right side endless belt conveyors and moves it backwards to a feeder house that carries the crop material upward, rearward, and into the agricultural harvester itself.

A feed drum is typically provided over a rear portion of the center endless belt conveyor just at or slightly forward of the forward opening of the feeder house. The feed drum is driven in rotation and compresses the crop material downwards (i.e. in a vertical direction) against a floor pan that is substantially as wide as the feed drum itself and disposed immediately below the feed drum. These feed drums typically have elongate fingers that extend outward from the outer skin of the drum. The fingers extend into the light, thick crop mat, pulling the crop mat rearward and underneath the feed drum itself as the drum compresses the crop in a vertical direction. The feed drum compresses the crop mat, reducing its height, while drawing it rearward, thereby permitting the crop mat to be more easily inserted into the opening of the feeder house itself.

Traditionally, these fingers have been mounted on an offset shaft disposed inside the feed drum itself. This offset shaft is typically offset slightly forward of and slightly above the central rotational axis of the feed drum. The function of the offset shaft is to support the base of the fingers for rotation about an axis that is slightly forward of the rotational axis of the drum.

By supporting the fingers offset from the drum rotational axis, each finger is extended its maximal distance through a hole in the drum surface at the point in the finger's rotation when it first engages the crop mat. This is typically the position in which the finger extends forwardly and generally horizontally from the drum.

As the drum rotates further, the finger moves downward and rearward, pulling the crop mat underneath the drum. At the same time the finger withdraws into the feed drum. The crop mat is compressed between the bottom surface of the drum and a floor pan. The floor pan extends generally fore and aft underneath the bottom of the feed drum. The finger is retracted by the location of the offset shaft so it does not interfere with the floor pan as the crop mat compresses and the gap between the bottom of the feed drum and the floor plan decreases.

Over the years, draper heads have been made wider and wider, capable of harvesting in carrying a greater mass of crop as they travel through the field. As a result, the crop maps have become thicker and wider as they are presented to the feed drum. The crop mats are so wide that they must be compressed laterally inward to be received into the opening of a typical agricultural harvester feeder house. This lateral compression has been difficult.

In one arrangement for laterally compressing the crop mat, auger fighting has been provided on the outer surface of the feed drum that tapers inward as it draws the crop mat backward to direct the crop inward from the outer edges of the center conveyor toward the center portion of the feed drum. Unfortunately, this arrangement commonly causes slug feeding of the crop into the feeder house.

Alternatively, diverters have been disposed to compress the crop and guide it to the middle of the feed drum.

It would be desirable to have an apparatus for laterally compressing the crop mat as well as vertically compressing the crop mat. It is an object of this invention to provide such a system in the embodiment described in claim one. Further advantages are provided by the alternative arrangements described in the additional claims.

### SUMMARY

In accordance with one aspect of the invention, a feed drum is provided having fingers extending therefrom that translate laterally with respect to the feed drum. The outer ends of the fingers translate laterally with respect to the feed drum. The feed drum includes at least one finger on the left side of the feed drum that translates rightward, and toward the axial midpoint of the feed drum. The feed drum includes at least one finger on the right side of the feed drum that translates leftward and toward the axial midpoint of the feed drum. The translating fingers slide laterally with respect to the surface of the feed drum. As the feed drum rotates each of the fingers lies in a plane. The fingers define a plane as they rotate. The plane that is defined by the fingers is not normal to the rotational axis of the feed drum. Instead, the plane that is defined by the fingers is disposed at an angle with respect to the rotational axis of the feed drum. The fingers are driven in rotation by the feed drum. The fingers extend through apertures (typically slots) in the feed drum and translate laterally in the apertures with respect to the surface of the feed drum as the feed drum rotates about its longitudinal axis. As in the conventional arrangement, a sidewall of the aperture pushes the finger in rotation simultaneously as the finger moves laterally in the aperture.

In accordance with another aspect of the invention, a finger shroud is supported on a feed drum to translate laterally with respect to the feed drum thereby preventing crop matter from being jammed into the hollow feed drum.

In accordance with another aspect of the invention, laterally translating fingers are disposed on opposing sides of the feed drum to simultaneously engage the crop mat and pull the crop mat inward from both sides of the feed drum toward a center plane of the feed drum two more evenly compact of the crop across the width of the feed drum and thereby more easily feed a greater mass of crop into the opening of the feeder house.

In accordance with another invention, a first finger that rotates in a plane perpendicular to the rotational axis of the feed drum is disposed between two laterally translating fingers to stabilize the center portion of the crop mat and help pull it underneath the feed drum as the two laterally translating fingers disposed on either side of the first finger laterally compress the crop mat toward the first finger.

The fingers are supported on an angularly offset mount within the feed drum such that as the fingers rotate downward from the forward position, engaging the crop mat, they are retracted into the feed drum and also translate laterally in the apertures in the drum toward the axial midpoint of the feed drum. As the fingers continue their rotation from the rear of the feed drum, across the top of the feed drum, and back again to the generally horizontal and forwardly pointing position, the fingers simultaneously translate laterally outward and away from the axial midpoint of the feed drum and are extended outward from the surface of the drum.

In accordance with another aspect of the invention, a feed drum arrangement for an agricultural harvesting head is provided, comprising a cylindrical drum that is hollow and has a central longitudinal axis, first and second ends fixed to the cylindrical drum; a shaft extending through the cylindrical drum and supporting the cylindrical drum for rotation about the central longitudinal axis, the shaft having an offset shaft portion extending generally parallel to and spaced away from the drum axis of rotation; a first finger mount supported on the offset shaft portion for rotation about the offset shaft portion about a first finger axis of rotation; and a first finger mounted in the first finger mount to rotate about the first finger axis of rotation, wherein an outer end of the first finger extends through the sidewall of the drum and the first finger is driven in rotation by the drum; wherein the first finger axis of rotation is not parallel to the central longitudinal axis.

A first plane may pass through a point on the central longitudinal axis and located at the middle of the feed drum, in which the first plane is normal to the central longitudinal axis, and the outer end of the first finger translates toward the first plane as the finger draws cut crop material rearward under the feed drum. The first finger rotational axis at the finger mount is disposed forward of the central rotational axis. The first finger may withdraw into the feed drum as the first finger draws cut crop material rearward under the feed drum. The first finger may translate laterally with respect to the feed drum as the feed drum rotates. The feed drum arrangement may also comprise a second finger mount supported on the offset shaft portion for rotation about the offset shaft portion about a second finger axis of rotation, a second finger mounted in the second finger mount to rotate about the second finger axis of rotation, wherein an outer end of the second finger extends through the sidewall of the drum and the second finger is driven in rotation by the drum; wherein a first plane passes through a point on the central longitudinal axis that is located at the middle of the feed drum, wherein the first plane is normal to the central longitudinal axis; and wherein the second finger axis of rotation is not parallel to the central longitudinal axis. The outer end of the first finger and the outer end of the second finger may translate toward the first plane as the first and second fingers draw cut crop material rearward under the feed drum. The first finger and the second finger may both be disposed on the same side of the first plane. The first finger axis of rotation and the second finger axis of rotation may be parallel and spaced apart. The first finger and the second finger may be disposed on opposite sides of the first plane. The feed drum arrangement may further comprise a third finger mount supported on the offset shaft portion for rotation about the offset shaft portion about a third finger axis of rotation; a third finger mounted in the third finger mount to rotate about the third finger axis of rotation, wherein an outer end of the third finger extends through the sidewall of the drum and the third finger is driven in rotation by the drum; wherein the third finger axis of rotation is parallel to the central longitudinal axis. The third finger mount may be disposed between the first finger mount and the second finger mount.

### BRIEF DESCRIPTION OF THE DRAWINGS

FIG. 1 illustrates an agricultural header, and in particular a draper header in accordance with the present invention.

FIG. 2 is a partial cutaway plan view of the feed drum shown in FIG. 1.

FIG. 3 is a view of the feed drum and the exposed finger of FIG. 2 in a view normal to the surface of the feed drum at a location on the feed drum where the exposed finger extends through the feed drum.

FIG. 4 is a cross section of the finger and feed drum of FIG. 3, taken at section line 4-4 in FIG. 3.

FIG. 5 is a cross section of the finger and feed drum of FIG. 3, taken at section line 5-5 in FIG. 3.

### DETAILED DESCRIPTION

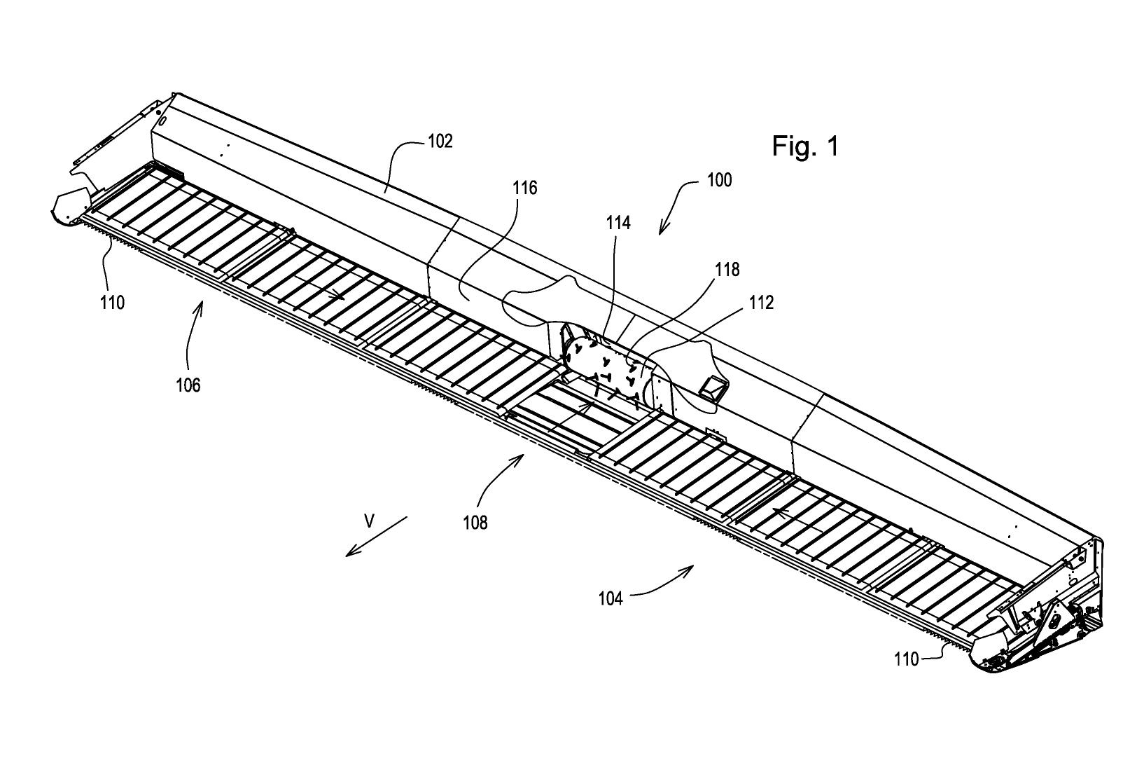

In FIG. 1, an agricultural harvesting head 100 includes a frame 102, left side endless belt conveyor 104, right side endless belt conveyor 106, center endless belt conveyor 108, elongate reciprocating knife 110, and feed drum 112 mounted in an aperture 114 located in a generally vertically oriented, central portion of rear wall 116 of the frame.

The agricultural harvesting head 100 is supported on a feeder house (not shown) located behind the aperture 114. The feeder house extends forward from the front end of a self propelled agricultural harvesting vehicle (not shown). The vehicle carries the agricultural harvesting head 100 forward through the field harvesting crops in the direction “V”. The elongate reciprocating knife 110 severs the stalks of the crop plants adjacent to the ground, whereupon they fall backward onto the left side endless belt conveyor 104, the right side endless belt conveyor 106, or the center endless belt conveyor 108.

The left side endless belt conveyor 104 and right side endless belt conveyor 106 move the crop inward toward a center portion of the agricultural harvesting head 100. This direction of crop movement is indicated by the arrows superimposed on the left side endless belt conveyor 104, and the right side endless belt conveyor 106.

The cut crop plants form a crop mat that is deposited on the center endless belt conveyor 108, which is driven in the direction indicated by the arrow superimposed on center endless belt conveyor 108.

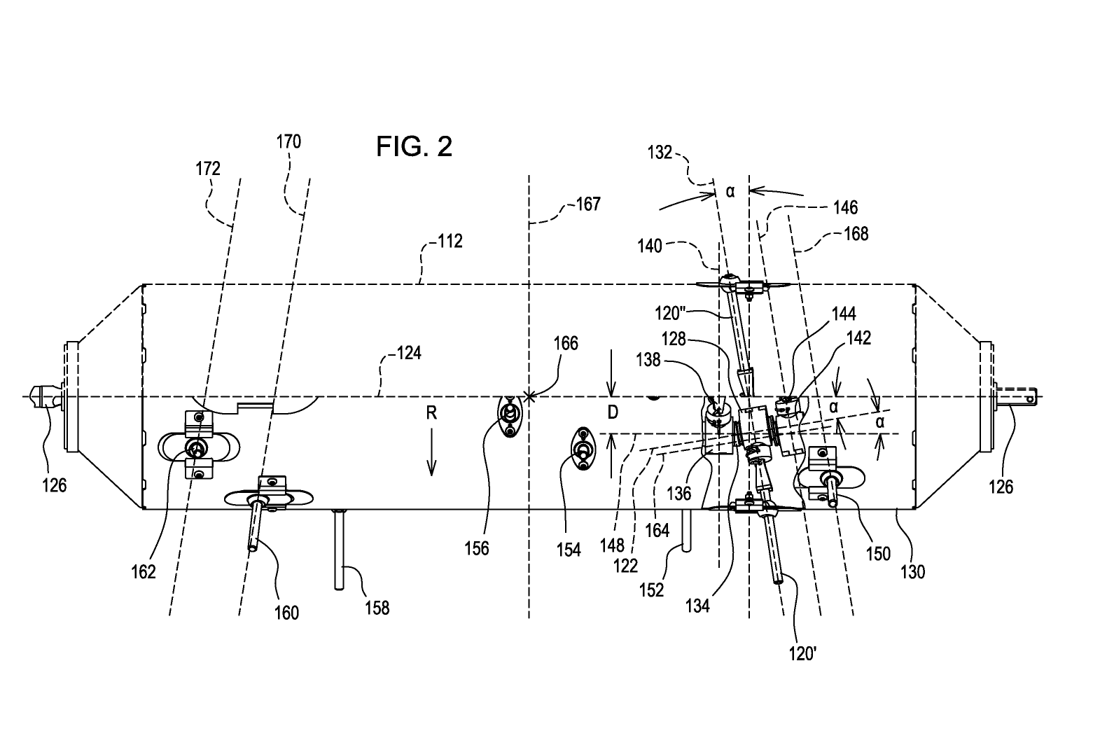

The crop mat is then pulled underneath the feed drum 112 by a combination of the movement of center endless belt conveyor 108 and a plurality of fingers 118 extending the outward from the surface of the feed drum 112. These fingers 118 are mounted on a shaft within the feed drum 112 (FIG. 2) such that they extend outward through holes provided in the hollow cylindrical portion of feed drum 112. The fingers 118 are driven in rotation by the feed drum 112 as it rotates. The fingers not only rotate as feed drum 112 rotates, they alternately extend outward and are retracted inward as the feed drum 112 rotates.

In FIG. 2, feed drum 112 is partially cut away and shows the feed drum 112 in two rotational positions.

In FIG. 2, fingers 118 of FIG. 1 are numbered individually as finger 120, finger 138, finger 144, finger 150, finger 152, finger 154, finger 156, finger 158, finger 160, and finger 162 in order to differentiate between the different types of fingers and to explain the differences in mounting, function, and orientation of each of the fingers.

All of the fingers extending from the feed drum 112, whether shown in full (such as the finger 120) or shown in part (such as finger 138, finger 144, finger 150, finger 152, finger 154, finger 156, finger 158, finger 160, and finger 162) are identically constructed and are mounted in identical finger mounts to an offset shaft portion 134 of shaft 126. All of the fingers have the same mechanical connection to their corresponding finger mounts. Furthermore, all of the finger mounts which mount the fingers to the offset shaft portion 134 are identical. In fact, the only difference in arrangement between each of the fingers and each of the finger mounts is the angle at which the finger mounts are disposed with respect to axis of rotation 124 of feed drum 112. The only difference in construction between the fingers is the overall length of the finger itself.

In the upper half of FIG. 2, the feed drum 112 is shown in phantom lines in the position it would be in when the finger 120 extends horizontally and rearward (this is shown in the upper half of FIG. 2 as position 120″). In the lower half of FIG. 2 the feed drum 112 is shown 180° of rotation from the position in the upper half of the Figure the position, which is the position it would achieve when the finger 120 extends horizontally and forward (shown in the lower half of FIG. 2 as position 120′.

Axis of rotation 122 of the finger 120 is disposed at an angle a with respect to axis of rotation 124 of the feed drum 112 about shaft 126. As shown here, the angle a is between 5° and 25°. More preferably angle a is between 8° and 20°.

The finger 120 is supported in a finger mount 128 which is supported on shaft 126. The finger mount 128 is supported on shaft 126 to rotate freely about shaft 126 and thereby to permit finger 120 rotate freely about shaft 126. As feed drum 112 rotates the outer skin 130 of feed drum 112 pushes against the shank of the finger 120 and rotates the finger 120 in a circular path 132. Circular path 132 is shown edge-on in FIG. 2, and is therefore drawn as a straight, dashed line.

Feed drum 112 is supported on bearings on shaft 126 to rotate with respect to shaft 126. Shaft 126 is stationary and does not rotate. Shaft 126 extends the entire length of feed drum 112. Shaft 126 is disposed within feed drum 112. Shaft 126 includes an offset shaft portion 134 that extends substantially the entire width of the feed drum. offset shaft portion 134 is parallel to and forward of axis of rotation 124 of the feed drum 112. Shaft 126 extends from both ends of the feed drum 112.

All the finger mounts (including finger mount 128) for all of the fingers extending from the cylindrical outer surface of feed drum 112 (some of which are hidden in the FIG. 2 view) are mounted for rotation on offset shaft portion 134 such that they rotate about offset shaft portion 134.

In the lower right hand cutaway portion of feed drum 112 shown in FIG. 2, three of these finger mounts are illustrated.

The first of these illustrated mounts, finger mount 128, supports the finger 120 for rotation about offset shaft portion 134 in a circular path 132.

The second of these illustrated mounts, finger mount 136, supports the finger 138 for rotation about offset shaft portion 134 in a circular path 140.

The third of these illustrated mounts, finger mount 142, supports the finger 144 for rotation about offset shaft portion 134 in a circular path 146.

All of the fingers described herein trace out a circular path. Each of these circular paths defines a plane of rotation. For finger 120, finger 144, finger 150, finger 160, and finger 162 these planes are offset at an angle α (alpha) with respect to a plane normal to the axis of rotation 124 of feed drum 112.

Finger mount 136 is supported on offset shaft portion 134 to rotate about offset shaft portion 134 about an axis of rotation 148 that is parallel to and disposed forward of axis of rotation 124 of feed drum 112. Since axes of rotation 124, 148 are parallel, finger 138 does not translate axially (laterally) with respect to the outer skin 130 of feed drum 112 as finger 138 rotates about shaft 126.

Finger 138 extends from its finger mount 136 outward and through the outer cylindrical surface of feed drum 112 throughout its entire path of rotation. The outer portion of finger 138 follows a circular path 140 that is perpendicular to the axis of rotation 124 of feed drum 112. Hence, the angle between axis of rotation 148 of finger mount 136 (and finger 138) and axis of rotation 124 of feed drum 112 is 0° (zero degrees).

Finger mount 142 is supported on offset shaft portion 134 to rotate about offset shaft portion 134 about an axis of rotation 164 that is (1) parallel to axis of rotation 122 of the finger 120 and is (2) at an angle α (alpha) with respect to axis of rotation 124 of feed drum 112. Since axis of rotation 124 and axis of rotation 164 are disposed at an angle a (alpha) with respect to each other, finger 144 translates axially (laterally) with respect to the outer skin 130 of feed drum 112 in the same amount that the finger 120 translates with respect to the outer skin 130 of feed drum 112.

Finger 144 extends from its finger mount 142 outward and through the outer cylindrical surface of feed drum 112 throughout its entire path of rotation. The outer portion of finger 144 follows a circular path 146 that is at an angle a with respect to the axis of rotation 124 of feed drum 112. Hence, the angle between axis of rotation 164 of finger mount 142 (and finger 144) and axis of rotation 124 of feed drum 112 is α (alpha).

The feed drum 112 rotates about axis of rotation 124, which is offset from axis of rotation 148 by a distance “D”. The result is that the fingers alternately extend outward from the surface of outer skin 130 and are retracted inward with respect to the surface of outer skin 130.

Some of the fingers, in particular finger 152, finger 154, finger 156, and finger 158, rotate in circular paths about axis of rotation 148 that are perpendicular to the axis of rotation 124 and the axis of rotation 148 and are concentric with the axis of rotation 148. These generally circular paths are both parallel to and laterally spaced apart from circular path 140 of finger 138. Each of these circular paths define planes that are perpendicular to axis of rotation 148, and that are parallel to each other.

Other fingers, in particular finger 120, finger 144, finger 150, finger 160, and finger 162, rotate in circular paths that are not perpendicular to the axis of rotation 124 and not perpendicular to the axis of rotation 148. These fingers are supported in finger mounts that are fixed to the offset shaft portion 134 of shaft 126 in order to rotate with respect to the offset shaft portion 134 of shaft 126 in circular path 132, circular path 146, circular path 168, circular path 170, circular path 172, that are disposed at an angle (e.g. angle “α”) with respect to the axis of rotation 124 of feed drum 112.

In the preferred arrangement shown here, finger 120, finger 144, and finger 150, are disposed to rotate about parallel axes that pull crop from the right end (as shown in FIG. 2) of feed drum 112 toward the axial midpoint 166 of feed drum 112 from right to left. A plane 167 is shown in FIG. 2 that is normal to axis of rotation 124 and passes through axial midpoint 166.

At the other, left end of the feed drum, finger 160 and finger 162 are disposed to rotate about parallel axes at angle a that pull crop from the left end (as shown in FIG. 2) of feed drum 112 toward axial midpoint 166 of feed drum 112 from left to right.

Thus, the finger 160 and finger 162 (which are angularly offset) on the left side of the drum draw the cut crop material to the right toward the middle of the drum as finger 120, finger 144, and finger 150 (which are angularly offset) draw the cut crop material to the left toward the middle of the drum. All of the angularly offset finger's preferably are set at the same angle (in one direction at an angle a for the right side fingers, and tilted in the other direction at an angle -a for the left side fingers) with respect to the axis of rotation 124 of feed drum 112. Feed drum 112 rotates in the direction “R” which is shown in FIG. 2 superimposed on the top of the feed drum.

By providing finger mounts for finger 120, finger 144, finger 150, finger 160, and finger 162 that constrain each finger to follow a circular path that is angularly offset with respect to the axis of rotation 124, the outer tips of the fingers can be caused to simultaneously sweep out a circular path and also move laterally inward toward the axial midpoint 166 of the feed drum 112, and then move laterally outward away from the axial midpoint 166.

In the preferred arrangement shown here, in which the cut crop is drawn underneath the feed drum 112, this lateral inward movement of the fingers toward the axial midpoint 166 occurs when the finger 120, finger 144, finger 150, finger 160, and finger 162 move from their forward facing and generally horizontal position in which they are substantially entirely extended, then continue their rotation downwards to a partially retracted and generally vertical position in which they engage the crop mat passing underneath the feed drum 112, and then continue further in their rotation to a rearward facing and generally horizontal position in which the finger 120, finger 144, finger 150, finger 160, and finger 162 are substantially entirely retracted. In FIG. 2, the extreme inward position in which the finger 120 is closest to the axial midpoint 166 is shown as the finger 120 in the position 120″. The extreme upward position in which the finger 120 is farthest from the axial midpoint 166 is shown as the finger 120 in the position 120′.

When the feed drum 112 is rotated, all the other fingers (e.g. finger 144, finger 150, finger 160, and finger 162) that are mounted on finger mounts that have rotational axes disposed at an angle (e.g. the angles α, −α shown herein) would pass through similar extreme inward and extreme outward positions since their centers of rotation are all disposed on a line (collinear with axis of rotation 148) disposed in front of the axis of rotation 124 and parallel to that axis of rotation.

The finger 120, finger 144, finger 150, finger 160, and finger 162 do not simultaneously engage the crop mat and compress it laterally inward toward the axial midpoint 166. Each finger 120, 144, 150, 160, 162 extends from the surface of the drum at a different angular location around the circumference of the drum. In FIG. 2, the finger 120 in position 120′ is the farthest advanced on the outer surface of the feed drum 112. It is followed by finger 160, which is angularly and circumferentially displaced on the surface of the drum from the finger 120 in a direction opposite of the direction of rotation “R” at an angle of approximately 20°. Finger 160 is then followed by finger 150, which is similarly angularly displaced a further 20°. Finger 150 is followed by finger 162 which is similarly angularly displaced a further 20° away.

In FIG. 2, only the forward quarter of the outer surface of the feed drum 112 is shown in detail. However this pattern of angular displacement of the finger 120, finger 144, finger 150, finger 160, and finger 162 is repeated on the other three quadrants of the surface of the feed drum 112 by other fingers (not shown) that are angularly displaced in the circumferential direction.

Therefore, as the finger 120, finger 144, finger 150, finger 160, and finger 162 rotate, pulling the crop underneath feed drum 112 and as the feed drum 112 compresses the crop mat, each finger engages the crop mat in turn, following the previous finger in succession. Due to the close circumferential and angular spacing of the finger 120, finger 144, finger 150, finger 160, and finger 162, at least two, and typically three or four of the fingers will be engaged in the crop mat at the same time. This permits a plurality of the fingers to be embedded in the crop mat and work simultaneously to draw the crop mat not only rearward and underneath the feed drum 112, but to work simultaneously to draw the crop mat inwardly toward the axial midpoint 166 of feed drum 112.

Further, since several of the finger 120, the finger 144, the finger 150, the finger 160, and the finger 162 extend from the outer surface of the feed drum in circumferentially displaced angular positions that permit them to be simultaneously engaged in the crop mat as described above, then at least one finger on opposite sides of the axial midpoint 166 (i.e. at least one of finger 120, finger 144, and finger 150 combined with at least one of finger 160 and finger 162) are disposed to be simultaneously embedded in the crop mat and to work together to compress the crop mat between them in opposite directions (i.e. from left to right by finger 160, and finger 162, and from right to left by finger 120, finger 144, and finger 150) and toward the axial midpoint 166.

In the partial cutaway shown in FIG. 2, only a few of the fingers are shown extending from the feed drum 112. It should be understood that the fingers are distributed generally evenly across the entire surface of the outer skin 130 to provide a smooth, steady draw of the crop mat from the center conveyor to the feeder house while simultaneously compressing the crop mat in a vertical direction and inwardly from both ends in a lateral direction toward the axial midpoint 166 of the feed drum 112.

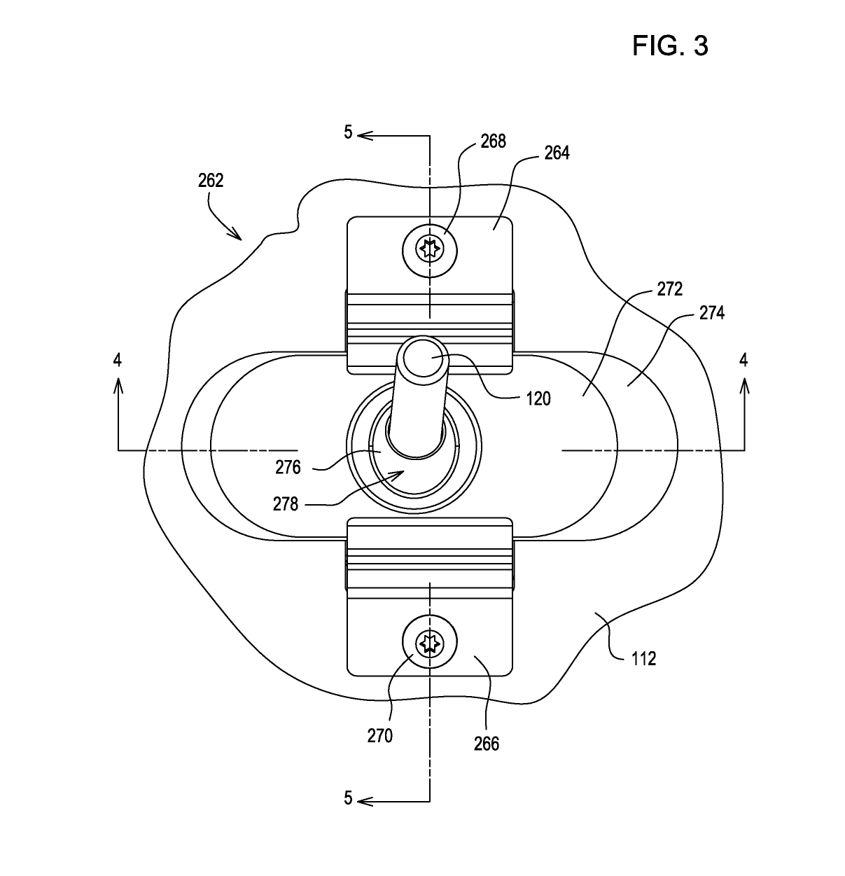

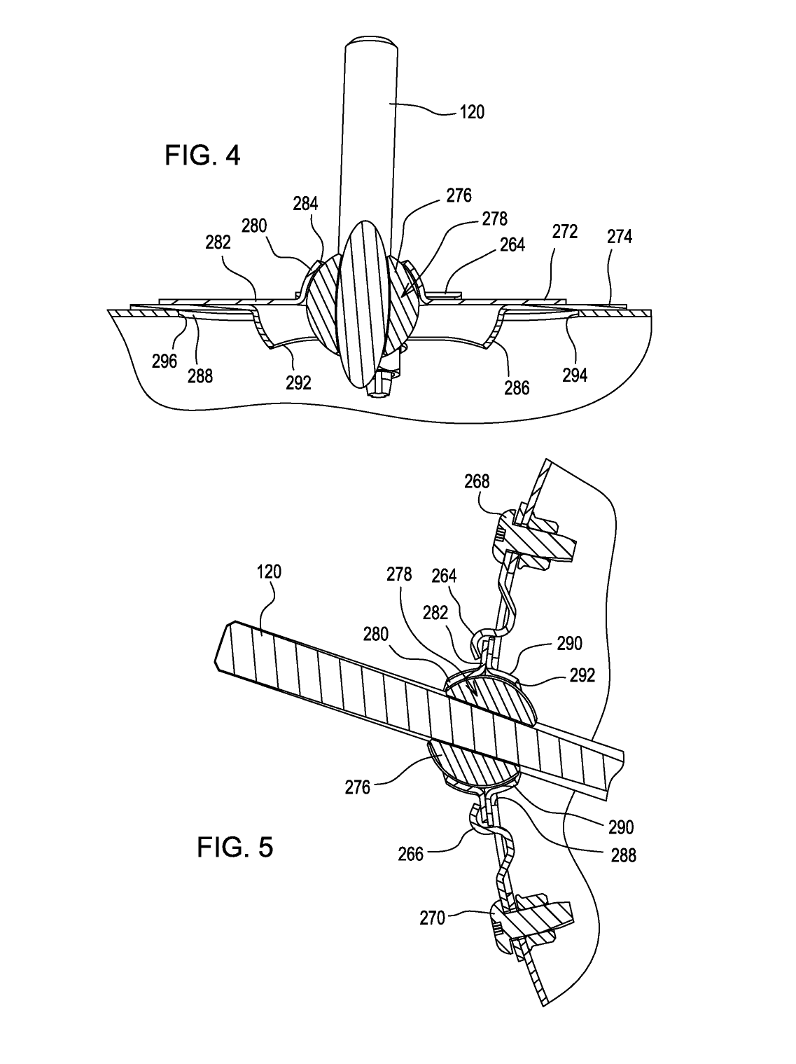

The other fingers shown in FIG. 2 include finger 138, finger 154, finger 156, and finger 158. These fingers are supported on offset shaft portion 134 to rotate about axis of rotation 148. They, like all the other fingers described herein, follow circular paths. The circular paths followed by finger 138, finger 154, finger 156 and finger 158 define planes that are perpendicular to the axis of rotation 124 and are parallel to plane 167. These fingers are not angularly offset, nor do they translate with respect to the outer skin 130 of feed drum 112. They are of conventional design and therefore do not have a finger shroud 262 described in conjunction with FIGS. 3, 4, 5 that permit the finger 120, finger 144, finger 150, finger 160, and finger 162 to translate laterally with respect to the outer skin 130 of feed drum 112.

Referring now to FIGS. 3, 4, 5, a finger shroud 262 is provided to permit the finger 120, finger 144, finger 150, finger 160, and finger 162 to translate laterally with respect to the feed drum 112 as the feed drum 112 rotates. Finger shroud 262 surrounds the finger 120, finger 144, finger 150, finger 160, and finger 162 and extends between the fingers and the outer surface of feed drum 112. Finger shroud 262 fills in the gap between the outer surface of feed drum 112 and the shaft of the finger. Finger shroud 262 translates laterally with respect to the outer surface of feed drum 112 to ensure that gaps between aperture 288 in the outer surface of feed drum 112 and the outer surface of the finger 120 that extends through aperture 288 are always filled to prevent plant matter to fall into the hollow internal space of feed drum 112.

In FIGS. 3-5, the finger is identified as the finger 120. It should be understood that a finger shroud 262 that is identical is provided for each of finger 120, finger 144, finger 150, finger 160, and finger 162 that translate laterally with regard to the surface of the feed drum 112. The description below is there for the same for the finger shrouds of each of the laterally translating fingers.

In FIG. 3, a retainer 264 and a retainer 266 are removably fixed to the outer surface of feed drum 112 with threaded fasteners 268, 270, respectively. The retainer 264 and the retainer 266 retain a plate 272 and a plate 274 against the surface of feed drum 112. A slight clearance is provided between retainer 264 and retainer 266, and plate 272 and plate 274, respectively, to permit plate 272, and plate 274 to slide laterally, in a direction parallel to the axis of rotation 124, with respect to the surface of feed drum 112. The finger 120 extends through a hole in a spacer 276 which is spherical. The spacer 276, in turn, is retained between plate 272 and plate 274, which define therebetween a cavity 278 in which a spacer 276 is supported. The cavity in plate 272 is defined by a hemispherical protrusion 280 that extends upward from a generally planar portion 282 of plate 272. An aperture 284 is provided in the upper portion of hemispherical protrusion 280 that is small enough to prevent spacer 276 from passing through.

The cavity in plate 274 that receives spacer 276 is defined by protrusion 286 that is elongate and that extends downward into an aperture 288 that is formed in the outer surface of feed drum 112. The aperture 288 has an extent generally parallel to the axis of rotation 124 that is slightly longer than the length of protrusion 286 to thereby permit the plate 274 to translate in a direction generally parallel to the axis of rotation 236 within aperture 288. Protrusion 286 has an elongate aperture 292 defined by sidewalls 290. Sidewalls 290 are spaced apart a distance narrow enough to prevent spacer 276 from falling into the interior of feed drum 112.

As feed drum 112 rotates, the finger mount for the finger 120 causes the finger 120 to translate laterally (e.g. generally parallel to axis of rotation 124) with respect to the outer surface of feed drum 112. This lateral movement of the finger 120 acting against spacer 276 causes spacer 276 to likewise translate laterally with respect to the outer surface of feed drum 112.

Due to the offset of offset shaft portion 134 (which supports the finger mounts) with respect to the outer surface of feed drum 112, the finger 120 also extends and retracts with respect to the outer surface of feed drum 112. This extension and retraction is not communicated to spacer 276, which slides up and down along the shank of the finger 120, thereby staying a constant distance from axis of rotation 124.

The angle of the finger 120 also changes with respect to the outer surface of the feed drum 112 by tilting in a lateral direction. The spacer 276 accommodates this by pivoting with respect to the plate 272 and the plate 274 in a lateral direction. This tilt by spacer 276 can be seen in FIG. 2 by comparing the relative positions of spacer 276 as the finger 120 moves between position 120′ and position 120″, which are limiting positions (i.e. the extreme travel positions). Spacer 276 translates to an angle a toward one end of feed drum 112, and then reverses its motion and translates to an angle a for the other in and of feed drum 112. At the same time, spacer 276 tilts back and forth, spacer 276 also slides laterally, together with the plate 272 and the plate 274 (which retain the spacer 276 on the surface of feed drum 112) with respect to the outer surface of feed drum 112.

As the finger 120 translates laterally, it translates and rotates spacer 276 in the half spherical cavity defined between the plate 272 and the plate 274. Spacer 276, in turn, engages the hemispherical inner surface of the protrusion of plate 272 and translates plate 272 laterally. Plate 274 does not automatically translate with spacer 276. Spacer 276 is free to translate laterally within the protrusion 286 of plate 274 until spacer 276 reaches an end wall of the protrusion 286. When it reaches the end wall of protrusion 286, spacer 276 presses against plate 274 and moves plate 274 laterally. Plate 274 will translate with respect to the surface of feed drum 112 until protrusion 286 reaches either opposing end 294 or opposing end 296 of aperture 288. Aperture 288 has a lateral length sufficient to permit the plate 274 to follow spacer 276 over its entire range of motion without contacting the opposing end 294 or the opposing end 296 of aperture 288.

The description above describes a single embodiment of the feed drum arrangement which includes several inventions, at least one of which is claimed below. The claims below are not limited to the particular embodiment shown in the attached figures and described above. Other feed drum arrangements fall within the scope of the claims below.

1. A feed drum arrangement for an agricultural harvesting head, comprising:
a cylindrical drum that is hollow and has a central longitudinal axis an axial midpoint and first and second ends;
a shaft extending through the cylindrical drum and supporting the cylindrical drum for rotation about a drum axis of rotation that is coaxial with the central longitudinal axis, the shaft having an offset shaft portion extending generally parallel to and spaced away from the drum axis of rotation;
a first finger mount supported on the offset shaft portion for rotation about the offset shaft portion about a first finger axis of rotation; and
a first finger mounted in the first finger mount to rotate about the first finger axis of rotation, wherein an outer end of the first finger extends through a sidewall of the drum and the first finger is driven in rotation by the cylindrical drum;
wherein the first finger axis of rotation is not parallel to the drum axis of rotation.

2. The feed drum arrangement of claim 1, wherein a first plane passes through a point on the drum axis of rotation that is located at the axial midpoint of the feed drum, wherein the first plane is normal to the drum axis of rotation, and further wherein the outer end of the first finger translates toward the first plane as the finger draws cut crop material rearward under the cylindrical drum.

3. The feed drum arrangement of claim 2, wherein the first finger axis of rotation at the first finger mount is disposed forward of the drum axis of rotation.

4. The feed drum arrangement of claim 3, wherein the first finger is progressively withdrawn into the cylindrical drum by the offset shaft portion as the first finger progressively draws cut crop material rearward under the cylindrical drum.

5. The feed drum arrangement of claim 1, wherein the first finger translates laterally with respect to the cylindrical drum as the cylindrical drum rotates.

6. The feed drum arrangement of claim 5, wherein the first finger translates laterally toward the axial midpoint of the cylindrical drum as it is simultaneously withdrawn into the cylindrical drum.

7. The feed drum arrangement of claim 1, further comprising:
a second finger mount supported on the offset shaft portion for rotation about the offset shaft portion about a second finger axis of rotation;
a second finger mounted in the second finger mount to rotate about the second finger axis of rotation, wherein an outer end of the second finger extends through the sidewall of the cylindrical drum and the second finger is driven in rotation by the cylindrical drum;
wherein a first plane passes through a point on the drum axis of rotation, wherein the first plane is normal to the drum axis of rotation; and
wherein the second finger axis of rotation is not parallel to the drum axis of rotation.

8. The feed drum arrangement of claim 7, wherein the outer end of the first finger and the outer end of the second finger are disposed such that they translate toward the first plane as the first finger and the second finger draw cut crop material rearward under the cylindrical drum.

9. The feed drum arrangement of claim 7, wherein the first finger and the second finger are disposed such that they are withdrawn into the cylindrical drum as the first finger and the second finger draw cut crop material rearward under the cylindrical drum.

10. The feed drum arrangement of claim 7, wherein the first finger and the second finger are both disposed on the same side of the first plane.

11. The feed drum arrangement of claim 7, wherein the first finger axis of rotation and the second finger axis of rotation are parallel and spaced apart.

12. The feed drum arrangement of claim 7, wherein the first finger and the second finger are disposed on opposite sides of the first plane.

13. The feed drum arrangement of claim 7, further comprising:
a third finger mount supported on the offset shaft portion for rotation about the offset shaft portion about a third finger axis of rotation; and
a third finger mounted in the third finger mount to rotate about the third finger axis of rotation, wherein an outer end of the third finger extends through the sidewall of the cylindrical drum and the third finger is driven in rotation by the cylindrical drum;
wherein the third finger axis of rotation is parallel to the drum axis of rotation.

14. The feed drum arrangement of claim 13, wherein the third finger mount is disposed for rotation about the offset shaft portion between the first finger mount and the second finger mount.
